(19) United States
(12) Patent Application Publication
(10) Pub. No.: US 2004/0059594 A1
(43) Pub. Date: Mar. 25, 2004

(54) Method and system for sale of used electronic equipment

(75) Inventors: Yoshio Tamura, Saitama (JP); Michihiro Miyake, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/663,842

(22) Filed: Sep. 17, 2003

(30) Foreign Application Priority Data
Sep. 24, 2002 (JP) 2002-277885
Sep. 24, 2002 (JP) 2002-277886

(51) Int. Cl. G06F 17/60

(52) U.S. Cl. 705/1

(57) ABSTRACT

A used digital camera is purchased by a shop from a user. The shop checks whether the digital camera operates normally. When the digital camera operates normally, product data thereof is sent to a sales management server of a manufacturer through the Internet. The sales management server searches for the model of the digital camera on the basis of product data, and extracts model information. A label with the product information of the digital camera is glued on a packing box corresponding to the model. The packing box with the label is sent to the shop. The used digital camera is sold to another user after packing in the packing box. An operation manual corresponding to the model may also be sent to the shop.

### BACKGROUND OF THE INVENTION

1. Field of the Invention

The present invention relates to a method and system for sale of used electronic equipment in which the used electronic equipment purchased from a user is sold to another user.

2. Background Arts

Electronic equipment is expensive in general, but used electronic equipment is available at a lower price than a new one. A used digital camera, for example, is sold at a lower price than at the beginning of introduction to a market, so that a user can decide which digital camera to buy, the used one or new one, according to his needs.

To recycle a used digital camera, Japanese Patent Laid-Open Publication No. 2000-196931 discloses a digital camera which restricts the reading and deleting of image data stored in an internal memory with a specific code. In a shop, image data is read out of the used digital camera by use of the specific code. Read image data stored on another recording medium is returned to the original user. After deleting image data stored in the internal memory, the digital camera is subject to a battery charging process and a lens cleaning process. Then, the digital camera is sold in a resale market.

The used digital camera is often brought into a used camera shop without a packing box or an operation manual. If there are the packing box and the operation manual, they may be badly damaged or soiled. In this case, the shop has to sell the digital camera without being packed in the packing box or without the operation manual enclosed. Therefore, a user feels uneasy about the usage and condition of the used digital camera when buying it. The operation manual usually includes a warranty. Since the warranty of the used digital camera is different from that of the new one, selling the used digital camera with the operation manual for the new one is likely to cause misunderstanding.

### SUMMARY OF THE INVENTION

An object of the present invention is to provide a method and system for sale of used electronic equipment in which the used electronic equipment sold to a user is packed in a packing box indicating the condition thereof.

Another object of the present invention is to provide a method and system for sale of used electronic equipment in which the used electronic equipment is sold to a user with an operation manual exclusive to the used electronic equipment enclosed.

To achieve the above objects, a system for sale of used electronic equipment according to the present invention comprises a function check circuit provided in the electronic equipment, a data input-output device, and a model search device. The function check circuit checks whether the electronic equipment operates normally. When the electronic equipment operates normally, the data input-output device sends the product data including a model code read from the electronic equipment to a manufacturer of the electronic equipment. The model search device identifies the model of the electronic equipment by the product data. The manufacturer sends a part corresponding to the identified model to the shop.

The part may be a packing box for packing the electronic equipment. On the packing box, the model information of the identified model is printed. The product data includes used time information of the electronic equipment, and the used time information may be printed on the packing box.

The part may be an operation manual corresponding to the identified model. The product data includes the used time information of the electronic equipment, and the operation manual describes a warranty according to the used time information.

The product data may include the used time information of the electronic equipment. The part may include an operation manual corresponding to the identified model and a document describing a warranty according to the used time information.

Instead of providing a function check circuit with the electronic equipment, the data input-output device may have a function to check whether the electrical equipment works normally. The electronic equipment may be a digital camera.

According to the method and system for sale of used electronic equipment of the present invention, since a packing box with product information of used electronic equipment is sent from a manufacturer to a shop, the shop can sell the used electronic equipment packed in a neat packing box. The manufacturer can efficiently send only necessary parts to the shop. Selling the used electronic equipment with the operation manual, and operating time and a warranty indicating the condition thereof makes it possible for a user to buy it in a carefree manner.

### BRIEF DESCRIPTION OF THE DRAWINGS

The above objects and advantages of the present invention will become apparent from the following detailed descriptions of the preferred embodiments when read in association with the accompanying drawings, which are given byway of illustration only and thus do not limit the present invention. In the drawings, the same reference numerals designate like or corresponding parts throughout the several views, and wherein:

FIG. 1A is a front perspective view of a used digital camera;

FIG. 1B is a rear perspective view of the used digital camera;

FIG. 2 is a block diagram showing the schematic structure of the digital camera;

FIG. 3 is a schematic view showing the structure of a sales system of the used digital camera according to the first embodiment;

FIG. 4 is a flow chart of the sales system; and

FIG. 5 is a schematic view showing the structure of a sales system of the used digital camera according to the second embodiment.

### DETAILED DESCRIPTION OF THE EMBODIMENTS

(First Embodiment)

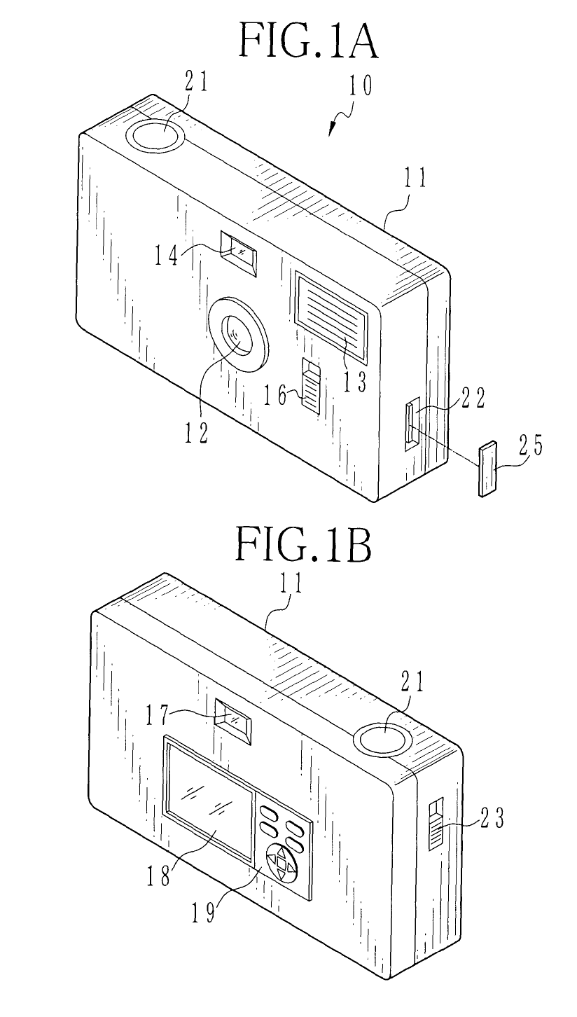

FIGS. 1A and 1B show a used digital camera 10 which is sold in a sales system of used electronic equipment. The front surface of a camera body 11 is provided with a taking lens 12, a flash projector 13, a view finder objective window 14, and a flash switch 16. The rear surface of the camera body 11 is provided with a viewfinder eyepiece window 17, a LCD 18 and an operation panel 19. A shutter button 21 is provided on the top surface of the camera body 11. A communication connector 22 and a power switch 23 are provided on one and the other side surfaces, respectively. A cover 25 covers the communication connector 22 during unused period in order to protect the communication connector 22 from damage and dust.

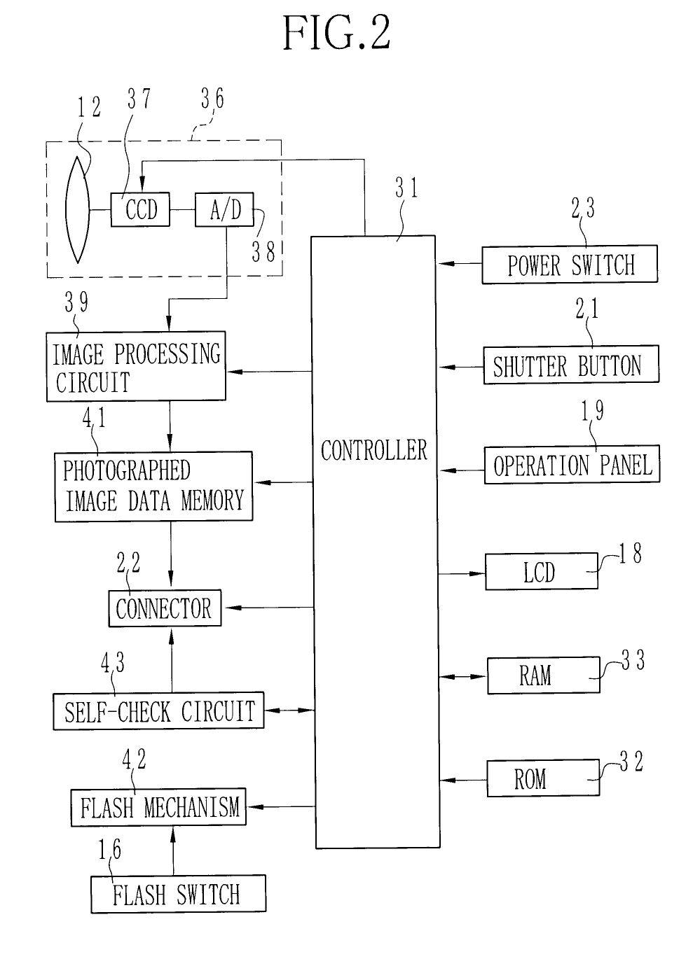

Referring to FIG. 2, the digital camera 10 has a controller 31 which executes various programs stored in a ROM 32 to control each part of the digital camera 10. A RAM 33 is used as a working memory when the controller 31 executes the various programs.

A photographing mechanism 36 comprises the taking lens 12, a CCD (Charge Coupled Device) 37, and an analog-to-digital converter 38. The CCD 37 converts subject light passing through the taking lens 12 into analog photographic signals. Then, the analog-to-digital converter 38 converts the analog photographic signals into digital photographic signals that are inputted into an image processing circuit 39 as image data. Instead of the CCD, a CMOS type of imaging device may be used.

Image data is subject to well-known corrective processes such as a white balance process and the like in the image processing circuit 39. Then, image data is recorded on an image memory 41 contained in the camera body 11 in a predetermined file format such as a JPEG (Joint Photographic Experts Group) format. In converting image data to the JPEG format, image data is irreversibly compressed. The compression rate of the JPEG format is changeable. The higher the compression rate, the more the image quality is degraded. Image data may be compressed in various compression formats except for the JPEG format.

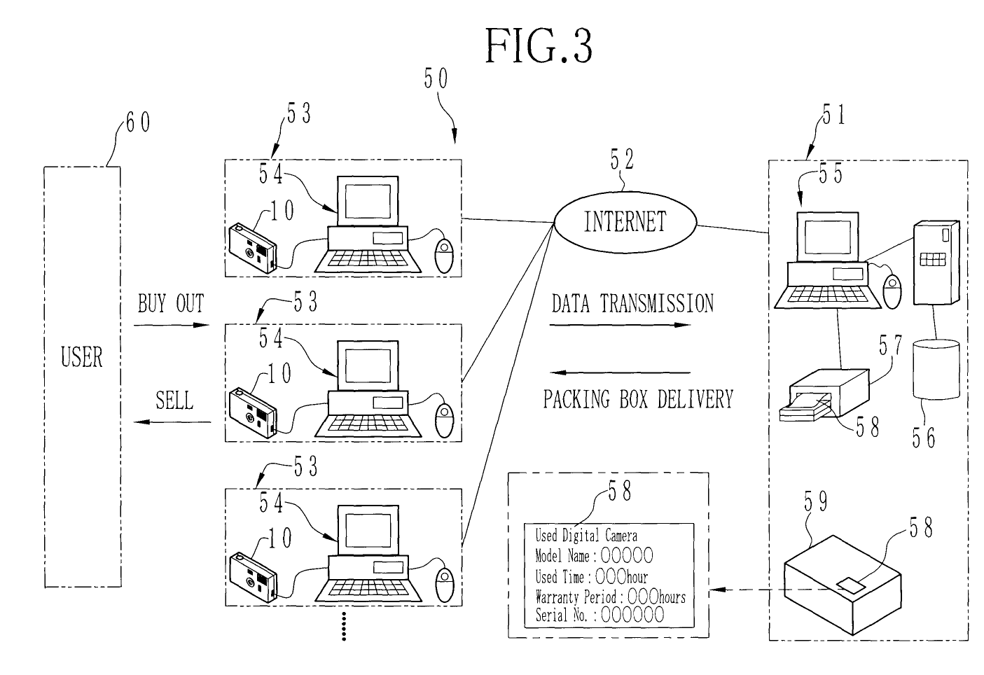

Image data in the image memory 41 can be sent to an external device (for example, a personal computer 54 of FIG. 3) via the communication connector 22. When a self-check circuit 43 for checking the functions of the digital camera 10 judges that the digital camera 10 operates normally, image data is sent to the personal computer 54 through the communication connector 22 and a connection cable (not-illustrated). At this time, product data stored in the image memory 41 including a model code, a serial number, used time and the like of the digital camera 10 is also sent to the personal computer 54. The self-check circuit 43 functions as a function check circuit, and the personal computer 54 functions as a data input-output device for sending and receiving product data. The model code and serial number of the digital camera 10 may be stored in the ROM 32.

A flash mechanism 42 comprises the flash projector 13 and a flash circuit. Upon turning on the flash switch 16, the flash circuit is activated to charge a main capacitor (not-illustrated). Then, since the main capacitor is discharged in synchronization with a push of the shutter button 21, a flashlight radiates from the flash projector 13 toward a subject.

The LCD 18 is used for replaying a photographed image, and displaying an operation window. The operation window includes a selection window for selecting each photographic mode. A user can change the display of LCD 18 by operating the operation panel 19 while following the guidance displayed in the operation window. In taking an image, it is possible to use the LCD 18 as an electronic viewfinder.

Referring to FIG. 3, a shop 53 purchases the used digital camera 10 from a user 60. The digital camera 10 is connected to the personal computer 54 with the connection cable. When the digital camera 10 normally operates, as described above, product data of the digital camera 10 is sent to the personal computer 54.

Product data sent to the personal computer 54 is also sent to a sales management server 55 in a manufacturer 51 through the Internet 52. The sales management server 55 refers to data of various products stored in storage 56 for obtained product data, in order to identify the model of the digital camera 10 and extract the model information corresponding to identified model. The sales management server 55 functions as a model search device for identifying the model of the digital camera 10.

The manufacturer 51 prepares a packing box 59 corresponding to the model of the digital camera 10, and prints the product information onto a label 58 by use of a printer 57 connected to the sales management server 55. On the label 58, a model name, used time, a warranty period and the serial number are printed in addition to indication that the digital camera is a used article. The label 58 is glued on the top surface of the packing box 59. The packing box 59 with the label 58 is sent to each used camera shop 53.

The shop 53 charges the battery and cleans the lens of the used digital camera 10. Then, the used digital camera 10 is sold to another user 60 after being packed in the packing box 59.

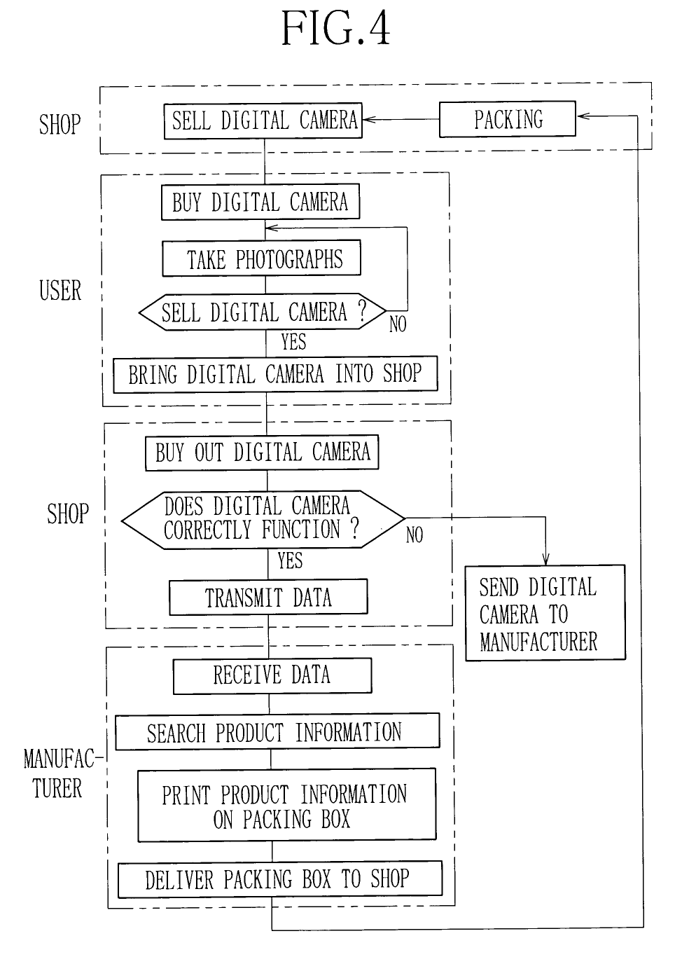

A flow of the sales system will be hereinafter described by referring to FIG. 4. The shop 53 sells the digital camera 10 to a user 60. After having photography with the digital camera 10, the user 60 brings the digital camera 10 into the shop 53 for trade-in.

The digital camera 10 is connected to the personal computer 54 in the shop 53. The self-check circuit 43 checks whether each function of the used digital camera 10 works normally or not.

If all the functions do not operate normally, product data of the digital camera 10 is not sent to the personal computer 54. The digital camera 10 is sent to a service center of the manufacturer 51 for repair. The repaired digital camera 10 is returned to the shop 53. At this time, it is preferable that the self-check circuit 43 detects a malfunctioning part to send the information thereof to the personal computer 54. Thus, the manufacturer 51 can efficiently repair the digital camera 10.

When all functions operate normally, product data of the digital camera 10 is sent to the personal computer 54. Product data is also sent to the sales management server 55 of the manufacturer 51 through the Internet 52.

The sales management server 55 searches for the model and model information of the digital camera 10 on the basis of product data. The printer 57 prints the product information including the model name, used time, warranty period, serial number and the like on the label 58. The manufacturer 51 glues the label 58 on the packing box 59 corresponding to the model of the digital camera 10, and sends them to the shop 53. The product information may be directly printed on the packing box 59.

The shop 53 sells the used digital camera 10 to another user 60 after packing it in the packing box 59 sent from the manufacturer 51. The shop 53 and the user 60 can easily distinguish the used digital camera 10 from new ones, because the label 58 indicating used article is glued on the top surface of the packing box 59.

In the above embodiment, the label 58 is glued on the packing box 59 in the manufacturer 51, but the label 58 may be glued in the shop 53. The product information of the digital camera 10 may be sent to the personal computer 54 of the shop 53 through the Internet 52, instead of being printed on the label 58 by the manufacturer 51.

According to the sales system 50 of the first embodiment, the shop 53 can sell the used digital camera 10 by packing it in the packing box 59 on which the product information corresponding to each digital camera 10 is indicated. The manufacturer 51 can efficiently send only the necessary packing box 59. The user 60 can buy the used digital camera 10 in a carefree manner because the used time, warranty period and the like as an index of quality are indicated on the packing box 59.

In the sales system 50 of the first embodiment, the corresponding packing box 59 and label 58 are sent to the shop 53, on the basis of product data of the digital camera 10 sent to the sales management server 55. In addition to the packing box 59 and label 58, an operation manual or a document describing changes in a warranty may be sent to the shop 53. According to a sales system of the used digital camera hereinafter described as a second embodiment, the operation manual or the document is sent to the shop 53. In the second embodiment, the same reference numbers as the first embodiment refer to identical parts, and the detailed explanation thereof is omitted.

(Second Embodiment)

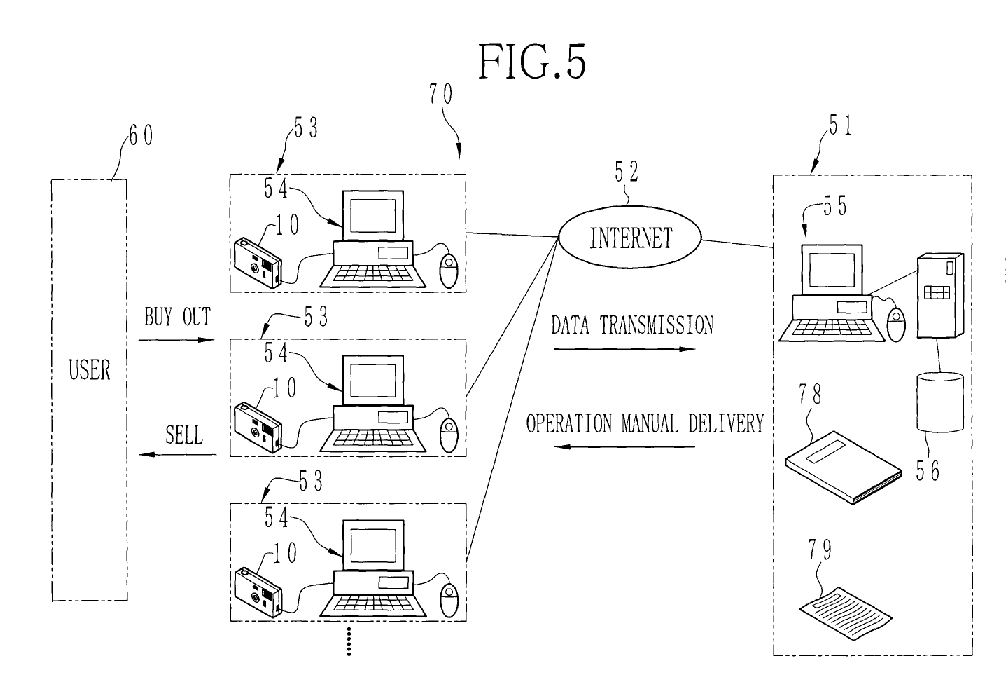

In a sales system 70 shown in FIG. 5, the user 60 brings the used digital camera 10 into the used digital camera shop 53. The digital camera 10 is connected to the personal computer 54, and the self-check circuit 43 checks the various functions thereof. When each function operates normally, product data including a model code, a serial number, used time and the like is sent to the personal computer 54.

Product data of the digital camera 10 is also sent to the sales management server 55 of the manufacturer 51 through the Internet 52. The sales management server 55 searches the storage 56 for the information of an operation manual and a warranty corresponding to the digital camera 10, on the basis of obtained product data. Then, the manufacturer 51 sends an operation manual 78 to the shop 53. The operation manual 78 describes the provisions of the warranty which are decided in accordance with the used time and the like.

The operation manual 78 including changes in the warranty is exclusive to the used digital camera 10. Instead of the operation manual 78 for the used digital camera 10, a document 79 describing changes in the warranty may be interposed into an operation manual for anew article. Costs are reduced in this case, because it is unnecessary to prepare the operation manual 78 only for the used digital camera 10.

Data of the operation manual 78 or the document 79 may be sent to the personal computer 54 of each shop 53 through the Internet. Thus, the operation manual 78 or the document 79 is printed in each shop 53.

The shop 53 sells the used digital camera 10 with the operation manual 78 to another user 60 after packing them in the packing box. Accordingly, the user can buy the used digital camera 10 without worrying about the usage and warranty thereof.

In the above embodiments, the self-check circuit 43 for checking various functions of the digital camera 10 is provided inside the camera body 11 as check means. Instead of the self-check circuit 43, a function check software may be installed in the personal computer 54 of the shop 53. In this case, the manufacturing cost of the digital camera 10 is reduced because it is unnecessary to provide the self-check circuit 43 in the individual digital camera 10.

In the above embodiments, the sales systems 50 and 70 are applicable to the digital camera 10, but the present invention is also applicable to other electronic equipment, such as a personal computer, a facsimile, a scanner, a printer, and a camera with a photo film.

In the above embodiments, the used digital camera 10 is brought into the used digital camera shop 53. A photo shop for developing a photo film, however, may purchase the used digital camera 10.

Although the present invention has been described with respect to the preferred embodiments, the present invention is not to be limited to the above embodiments but, on the contrary, various modifications will be possible to those skilled in the art without departing from the scope of claims appended hereto.

What is claimed is:

1. A system for selling electronic equipment brought into a shop as used electronic equipment, said system comprising:
a function check circuit provided in said electronic equipment, said function check circuit checking whether said electronic equipment operates normally;
a data input-output device for sending and receiving product data of said electronic equipment, said data input-output device sending said product data including a model code read from said electronic equipment to a manufacturer of said electronic equipment when said electronic equipment operates normally; and
a model search device for identifying the model of said electronic equipment on the basis of said product data, and said manufacturer sending a part corresponding to identified said model to said shop.

2. A system as recited in claim 1, wherein said part is a packing box for packing said electronic equipment.

3. A system as recited in claim 2, wherein model information of identified said model is printed on said packing box.

4. A system as recited in claim 2, wherein said product data includes used time information of said electronic equipment, and said used time information is printed on said packing box.

5. A system as recited in claim 1, wherein said part is an operation manual corresponding to identified said model.

6. A system as recited in claim 5, wherein said product data includes used time information of said electronic equipment, and said operation manual describes a warranty according to said used time information.

7. A system as recited in claim 1, wherein said product data includes used time information of said electronic equipment, and said part includes an operation manual corresponding to identified said model and a document describing a warranty according to said used time information.

8. A system as recited in claim 1, wherein said electronic equipment is a digital camera.

9. A system for selling electronic equipment brought into a shop as used electronic equipment comprising:
a data input-output device for sending and receiving product data of said electronic equipment, said data input-output device checking whether said electronic equipment operates normally, and wherein said data input-output device sends said product data read from said electronic equipment to a manufacturer of said electronic equipment when said electronic equipment operates normally; and
a model search device for identifying the model of said electronic equipment based on said product data, and said manufacturer sending a part corresponding to identified said model to said shop.

10. A system as recited in claim 9, wherein said part is a packing box for packing said electronic equipment.

11. A system as recited in claim 10, wherein model information of identified said model is printed on said packing box.

12. A system as recited in claim 10, wherein said product data includes used time information of said electronic equipment, and said used time information is printed on said packing box.

13. A system as recited in claim 9, wherein said part is an operation manual corresponding to identified said model.

14. A system as recited in claim 13, wherein said product data includes used time information of said electronic equipment, and said operation manual describes a warranty according to said used time information.

15. A system as recited in claim 9, wherein said product data includes used time information of said electronic equipment, and said part includes an operation manual corresponding to identified said model and a document describing a warranty according to said used time information.

16. A system as recited in claim 9, wherein said electronic equipment is a digital camera.

17. A method for selling electronic equipment brought into a shop as used electronic equipment, said method comprising the steps of:
(a) checking whether said electronic equipment operates normally;
(b) reading product data including a model code from said electronic equipment when said electronic equipment operates normally;
(c) sending said product data to a manufacturer of said electronic equipment; and
(d) identifying the model of said electronic equipment by said product data, in order to send a part corresponding to identified said model to said shop.

18. A method as recited in claim 17, wherein said part is a packing box for packing said electronic equipment, said method further comprises the step of:
(e) printing model information of identified said model on said packing box.

19. A method as recited in claim 18, wherein said product data includes used time information of said electronic equipment, said method further comprises the step of:
(f) printing said used time information on said packing box.

20. A method as recited in claim 17, wherein said part is an operation manual corresponding to identified said model.

21. A method as recited in claim 20, wherein said product data includes used time information of said electronic equipment, said method further comprises the step of:
(g) describing a warranty according to said used time information in said operation manual.
